(19) United States
(12) Patent Application Publication
(10) Pub. No.: US 2011/0093755 A1
(43) Pub. Date: Apr. 21, 2011

(54) UPLINK DATA TRANSMISSION METHOD AND TERMINAL APPARATUS

(76) Inventor: Wen GAO, Shenzhen (CN)

(21) Appl. No.: 12/975,602

(22) Filed: Dec. 22, 2010

Related U.S. Application Data
(63) Continuation of application No. PCT/CN2009/072210, filed on Jun. 10, 2009.

(30) Foreign Application Priority Data
Jun. 23, 2008 (CN) 200810067986.9

(51) Int. Cl. H04W 4/00; H04L 1/18; G06F 11/14

(52) U.S. Cl. 714/748; 370/338; 714/E11.131

(57) ABSTRACT

In the field of radio communications, an uplink data transmission method is provided, which includes: receiving first Physical Downlink Control Channel (PDCCH) signaling sent by a Base Station (BS); and if initial transmission is determined according to a New Data Indicator (NDI) of the first PDCCH signaling, determining that a Modulation Code Scheme (MCS) in the first PDCCH signaling is a normal MCS, and performing an uplink data transmission. A terminal apparatus is further provided. Therefore, the effectiveness of the uplink data transmission is guaranteed in the case that the PDCCH signaling of scheduling initial transmission is lost in the uplink data transmission, and when the uplink data is transmitted, packet loss and false indication of a lower layer to transmit data are avoided.

### CROSS-REFERENCE TO RELATED APPLICATIONS

This application is a continuation of International Application No. PCT/CN2009/072210, filed on Jun. 10, 2009, which claims priority to Chinese Patent Application No. 200810067986.9, filed on Jun. 23, 2008, both of which are hereby incorporated by reference in their entireties.

### FIELD OF THE TECHNOLOGY

The present invention relates to the field of wireless communications, and in particular, to an uplink data transmission method and a terminal apparatus.

### BACKGROUND OF THE INVENTION

In the Long Term Evolution (LTE) system, data that is sent in the radio air interface link needs to be scheduled. The radio air interface link is divided into an uplink and a downlink.

In the uplink, the Hybrid Automatic Repeat reQuest (HARQ) adopts synchronous transmission that includes an adaptive transmission and a non-adaptive transmission. Uplink transmission includes initial transmission and retransmission. In the dynamic scheduling, the initial transmission of data needs to be indicated by an Uplink grant (UL grant), and in the retransmission, if it is for the non-adaptive synchronous transmission, no indication is made by the UL grant; while if it is for the adaptive synchronous transmission, the UL grant is required to re-indicate the retransmission resources.

The UL grant is used to indicate the transmission resources of the uplink, which are included in Physical Downlink Control Channel (PDCCH) signaling. The PDCCH signaling contains the allocated radio resources, the Modulation Code Scheme (MCS), and the HARQ-related information, such as the Redundancy Version (RV) and the New Data Indicator (NDI).

In the prior art, it can be determined whether the transmitted data is initial transmitted or is retransmitted, according to changes of the NDI, and the length of NDI is 1 bit. If an increment occurs on the NDI, for example, when the NDI is 0, it increases to 1, or when the NDI is 1, it increases to 0, the transmission of the data is identified as the initial transmission. If an increment does not occur on the NDI, the transmission of the data is identified as the retransmission. As shown in Table 1, in the uplink transmission, 3 values (11101, 11110 and 11111) are reserved in the MCS of 5 bits to represent RV1, RV2 and RV3. When the MCS is a value other than the preceding 3 values, a default value RV0 is assigned to the MCS.

TABLE 1

| Signaled Value | Transport Format (TF) | | |
|---|---|---|---|
| (binary) | (e.g. MCS) | RV | Ranges |
| 00000 | . . . | 0 | TF |
| 00001 | . . . | 0 | (MCS) |
| 00010 | QPSK rate 0.25 | 0 | range |
| 00011 | QPSK rate 0.40 | 0 | |
| 00100 | . . . | 0 | |
| 00101 | . . . | 0 | |
| . . . | . . . | . . . | |
| 10111 | 16- QAM rate 0.50 | 0 | |
| 11000 | . . . | 0 | |
| 11001 | 64- QAM rate 0.65 | 0 | |
| 11010 | 64- QAM rate 0.70 | 0 | |
| 11011 | . . . | 0 | |
| 11100 | . . . | 0 | |
| 11101 | N/A | 1 | RV |
| 11110 | | 2 | range |
| 11111 | | 3 | |

A 1% loss probability exists when User Equipment (UE) receives the PDCCH signaling. If loss of PDCCH signaling of scheduling initial transmission occurs, the UE may cannot acquire the MCS in the PDCCH signaling of scheduling initial transmission, and thus a retransmission of the PDCCH signaling is required. There are three cases for scheduling retransmission:

1. The UE may not perform any action if no new PDCCH signaling is retransmitted, which means that the scheduling radio resources are suspended until the BS schedules and allocates the resources for the next time. This case can be eliminated only by means of reducing the loss probability.

2. If the UE loses the PDCCH signaling of scheduling initial transmission, and the RV contained in the next received PDCCH signaling is RV0, the UE may perform a normal uplink transmission based on the radio resources and MCS received for this time.

3. If the UE loses the scheduling PDCCH signaling of scheduling initial transmission, the RV contained in the next received PDCCH signaling is RV1, RV2 or RV3, and the UE does not obtain the MCS in the scheduling PDCCH signaling of scheduling initial transmission due to the loss of the scheduling PDCCH signaling of scheduling initial transmission. The UE may perform an initial transmission because the increment occurs on the NDI. The UE will continue to transmit the uplink data, and therefore, problems like packet loss and false indication of the physical layer to transmit data may arise because no MCS is obtained from the PDCCH signaling received this time.

The technical solutions in the prior art fail to solve the technical problems caused by the third case as described above.

### SUMMARY OF THE INVENTION

Accordingly, the embodiments of the present invention provide an uplink data transmission method and a terminal apparatus.

An embodiment of the present invention provides an uplink data transmission method, where the method includes: receiving first PDCCH signaling sent by a BS; and if initial transmission is determined according to an NDI in the first PDCCH signaling, determining that a MCS in the first PDCCH signaling is a normal MCS, and performing an uplink data transmission.

An embodiment of the present invention provides a terminal apparatus, where the apparatus includes: a receiving unit, configured to receive first PDCCH signaling sent by a BS; a determining unit, configured to determine whether a MCS in the first PDCCH signaling is a normal MCS if initial transmission is determined according to an NDI in the first PDCCH signaling received by the receiving unit; and a transmitting unit, configured to perform an uplink data transmission if the determining unit determines that the MCS is a normal MCS.

According to the technical solutions provided in the embodiments of the present invention, in the uplink data transmission, if the initial transmission is determined according to the NDI in the received PDCCH signaling sent by the BS, the UE determines whether the MCS in the PDCCH signaling sent by the BS is a normal MCS, and if yes, the UE performs the uplink data transmission. Therefore, the effectiveness of the uplink data transmission is guaranteed and when the uplink data is transmitted, packet loss and false indication of a lower layer to transmit data are prevented.

### BRIEF DESCRIPTION OF THE DRAWINGS

FIG. 1 is a flowchart of an uplink data transmission method according to an embodiment of the present invention;

FIG. 2 is a flowchart of an uplink data transmission method according to another embodiment of the present invention; and

FIG. 3 is a schematic diagram of the structure of a terminal apparatus according to an embodiment of the present invention.

### DETAILED DESCRIPTION OF THE EMBODIMENTS

To make the technical solutions and objectives of the present invention clearer, embodiments of the present invention are further described below with reference to the accompanying drawings.

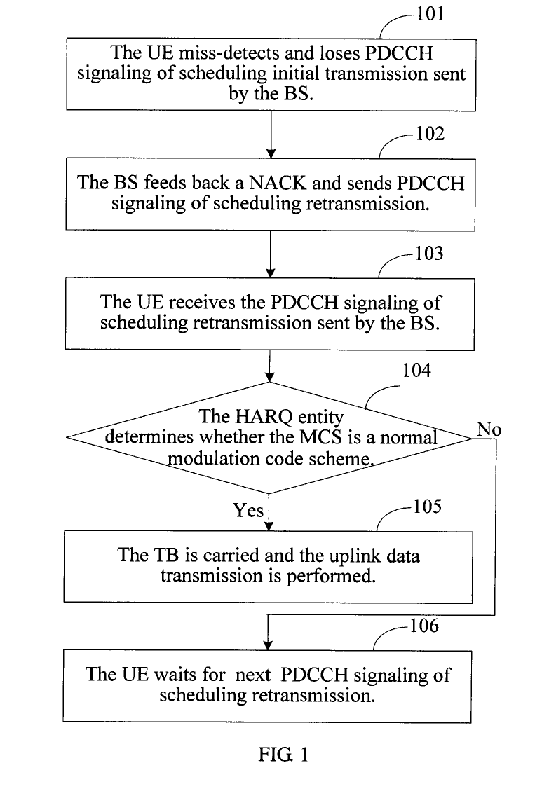

Referring to FIG. 1, an uplink data transmission method according to an embodiment of the present invention is provided. In this embodiment, after performing the last uplink data transmission, the UE may save the NDI received in the last transmission and make the saved NDI as a reference for the next uplink data transmission. After successfully receiving the uplink data sent by the UE, the BS may send an Acknowledgement (ACK) of a successful data reception to the UE, and continue to send PDCCH signaling of scheduling initial transmission for the next uplink data transmission to the UE.

In step 101, the UE loses the PDCCH signaling of scheduling initial transmission sent by the BS.

A 1% loss probability exists when the UE receives PDCCH signaling. In this embodiment, if the UE does not receive the PDCCH signaling of scheduling initial transmission sent by the BS and the NDI saved by the UE is 0, the NDI in the PDCCH signaling of scheduling initial transmission is 1. Because the UE fails to receive the PDCCH signaling of scheduling initial transmission, the UE does not perform the uplink data transmission.

In step 102, the BS sends a Negative Acknowledgement (NACK) and sends PDCCH signaling of scheduling retransmission.

If the BS fails to detect the uplink transmitted data sent by the UE, after sending the PDCCH signaling of scheduling initial transmission, the BS sends a NACK to the UE and sends the PDCCH signaling of scheduling retransmission to the UE. The NDI in the PDCCH signaling of scheduling retransmission is 1.

In step 103, the UE receives the PDCCH signaling of scheduling retransmission sent by the BS.

Because the UE does not perform the uplink data transmission, the UE does not read the NACK sent by the BS.

Because the probability of a PDCCH signaling lost by the UE is 1%, the PDCCH signaling of scheduling retransmission sent by the BS may no longer be lost in normal cases, after the UE loses the PDCCH signaling of scheduling initial transmission. The UE may determine whether a scheduled transmission is initial transmission or retransmission according to the NDI in the PDCCH signaling of scheduling retransmission, after receiving the PDCCH signaling of scheduling retransmission sent by the BS. In this embodiment, the NDI in the PDCCH signaling of scheduling retransmission received by the UE is 1, and the UE may update the saved NDI=0 as NDI=1. Therefore, an increment occurs on the NDI, and the scheduled transmission is determined as the initial transmission.

In step 104, if the MCS in the PDCCH signaling of scheduling retransmission is a normal MCS, step 105 is performed; otherwise, step 106 is performed.

The HARQ entity of the UE determines whether the MCS in the PDCCH signaling of scheduling retransmission is a normal MCS. If the RV in the PDCCH signaling of scheduling retransmission is RV0, the MCS in the PDCCH signaling of scheduling retransmission is determined as a normal MCS, and if the RV is RV1, RV2 or RV3, the MCS in the PDCCH signaling of scheduling retransmission is determined as an abnormal MCS. Alternatively, the determination whether it is a normal MCS may be directly implemented based on the MCS in the PDCCH signaling of scheduling retransmission, if the PDCCH signaling of scheduling retransmission contains a specific non-empty MCS, such as Quadrature Phase Shift Keying rate (QBSK rate) 0.25, 16-Quadrature Amplitude Modulation rate (QAM rate) 0.50 or 64-QAM rate 0.70, the MCS in the PDCCH signaling of scheduling retransmission is determined as a normal MCS, and if the MCS contained in the PDCCH signaling of scheduling retransmission is empty (N/A), the MCS in the PDCCH signaling of scheduling retransmission is determined as an abnormal MCS.

When receiving a PDCCH signaling sent by the BS, the UE does not know whether the PDCCH signaling is the PDCCH signaling of scheduling retransmission or the PDCCH signaling of scheduling initial transmission, so if the UE receives the PDCCH signaling of scheduling initial transmission sent by the BS, the same treatment may be performed on the PDCCH signaling of scheduling initial transmission as that performed on the PDCCH signaling of scheduling retransmission in step 103 and step 104. That is, after receiving the PDCCH signaling of scheduling initial transmission sent by the BS, the UE determines whether the scheduled transmission is initial transmission or retransmission according to the NDI in the PDCCH signaling of scheduling initial transmission, and if the scheduled transmission is initial transmission, further determines whether the MCS in the PDCCH signaling of scheduling initial transmission is a normal MCS, where if the MCS in the PDCCH signaling of scheduling initial transmission is a normal MCS, step 105 is performed; otherwise, step 106 is performed. The similar situations in this embodiment will not be described herein again.

In step 105, the UE performs the uplink data transmission.

If the MCS in the PDCCH signaling of scheduling retransmission acquired by the UE is a normal MCS, a data Transport Block (TB) to be transmitted is carried onto an HARQ Buffer, an HARQ process corresponding to an HARQ process Identity (ID) in the PDCCH signaling of scheduling retransmission is instructed to perform initial transmission, and the MCS is marked as normal, so that the HARQ process performs the uplink data transmission.

In step 106, the UE stops the uplink data transmission and waits for the next PDCCH signaling of scheduling retransmission.

If the MCS is an abnormal MCS, the MCS is marked as abnormal, and the UE does not perform the uplink data transmission and waits to receive the next PDCCH signaling of scheduling retransmission.

If the BS receives the uplink data sent by the UE and successfully decodes the data, after the UE sends the uplink data, the BS sends an ACK, indicating a successful data transmission by the UE.

If the BS does not receive the uplink data sent by the UE, or if the BS fails to decode the uplink data after receiving the uplink data sent by the UE, the BS sends a NACK to the UE and redelivers the PDCCH signaling of scheduling retransmission, the NDI contained in the retransmission scheduling PDCCH signaling is 1. The NDI saved in the UE is 1, and therefore the NDI does not change, which indicates that the UE needs to retransmit data. The HARQ entity of the UE firstly instructs the corresponding HARQ process to perform an adaptive retransmission, the HARQ process may check whether the MCS is marked as normal, and if the MCS is marked as normal, the HARQ process may perform the adaptive retransmission. If the indicated RV in the PDCCH signaling of scheduling retransmission sent again by the BS is RV1, RV2 or RV3, the corresponding HARQ process may be instructed to perform the adaptive retransmission by the normal MCS acquired in step 105. If the indicated RV in the PDCCH signaling of scheduling retransmission sent again by the BS is RV0, the indicated MCS in this PDCCH signaling of scheduling retransmission may be utilized to perform the adaptive retransmission. If the MCS is abnormal, the adaptive retransmission is not performed.

Alternatively, if the BS does not receive the uplink data sent by the UE, or if the BS fails to decode the uplink data after receiving the uplink data sent by the UE, the BS sends a NACK to the UE; however, the BS does not redeliver the PDCCH signaling of scheduling retransmission. Therefore, the HARQ entity of the UE firstly instructs the corresponding HARQ process to perform the non-adaptive retransmission, the HARQ process may check whether the MCS is marked as normal, and if the MCS is marked as normal, the retransmission may be performed in a non-adaptive manner. When the UE performs the retransmission in a non-adaptive manner, the normal MCS acquired in step 105 may be utilized, and the RV may be obtained in the order of RV0, RV2, RV3 and RV1. If the MCS is marked as abnormal, the retransmission is not performed.

According to the technical solutions provided in this embodiment, in the uplink data transmission, if the initial transmission is determined according to the NDI in the received PDCCH signaling sent by the BS, the UE determines whether the MCS in the PDCCH signaling sent by the BS is normal, and if the MCS is normal, performs the uplink data transmission. Therefore, the effectiveness of the uplink data transmission is guaranteed and when the uplink data is transmitted, packet loss and false indication of a lower layer to transmit data are avoided.

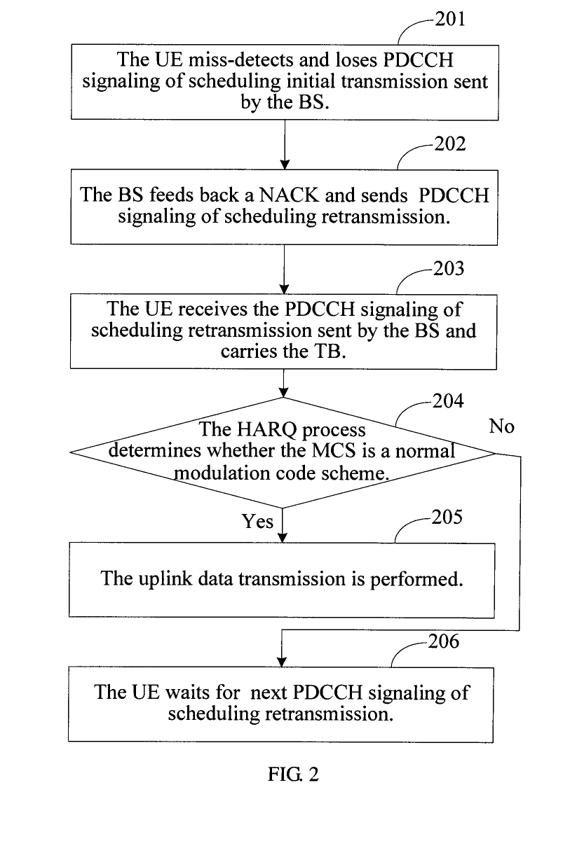

Referring to FIG. 2, an uplink data transmission method according to another embodiment of the present invention is provided, which includes the following steps.

Steps 201 to 202 are the same as steps 101 to 102 in the embodiment illustrated in FIG. 1.

In step 203, the UE receives the PDCCH signaling of scheduling retransmission sent by the BS.

Because the UE does not perform the uplink data transmission, the UE does not read the NACK sent by the BS.

The UE determines whether scheduled transmission is initial transmission or retransmission according to the NDI in the PDCCH signaling of scheduling retransmission, after normally receiving the PDCCH signaling of scheduling retransmission sent by the BS. In this embodiment, because the NDI in the received PDCCH signaling of scheduling retransmission is 1, this scheduled transmission is determined as the initial transmission. The HARQ entity carries the data TB to be transmitted onto the HARQ buffer and instructs the corresponding HARQ process to perform the uplink data transmission.

In step 204, if the MCS in the PDCCH signaling of scheduling retransmission is a normal MCS, step 205 is performed; otherwise, step 206 is performed.

The HARQ process determines whether the MCS in the PDCCH signaling of scheduling retransmission is a normal MCS. The determination method is the same as that in the embodiment illustrated in the FIG. 1 and will not be described herein again.

In step 205, if the MCS is a normal MCS, the HARQ process performs the initial transmission, and the MCS is marked as normal, so that the uplink data transmission is performed.

In step 206, if the MCS is an abnormal MCS, the UE does not perform the uplink data transmission, and the MCS is marked as abnormal.

According to this embodiment, if the BS receives the uplink data sent by the UE and successfully decodes the data, the BS sends an ACK to the UE, indicating a successful uplink data transmission for this time.

If the BS does not receive the uplink data sent by the UE, or if the BS fails to decode the data after receiving the uplink data sent by the UE, the BS sends a NACK to the UE and redelivers the PDCCH signaling of scheduling retransmission, the NDI contained in the PDCCH signaling of scheduling retransmission is 1. The NDI saved in the UE is 1, and therefore the NDI does not change, which indicates that the UE needs to perform the data retransmission. The HARQ entity of the UE firstly instructs the corresponding HARQ process to perform the adaptive retransmission, the HARQ process may check whether the MCS is marked as normal, and if the MCS is marked as normal, the HARQ process may perform the adaptive retransmission. If the indicated RV in the PDCCH signaling of scheduling retransmission sent again by the BS is RV1, RV2 or RV3, the normal MCS acquired in step 205 may be utilized to perform the adaptive retransmission. If the indicated RV in the PDCCH signaling of scheduling retransmission sent again by the BS is RV0, the indicated MCS in this PDCCH signaling of scheduling retransmission may be utilized to perform the adaptive retransmission. If the MCS is marked as abnormal, the adaptive retransmission is not performed.

If the BS does not receive the uplink data sent by the UE, or if the BS fails to decode the data after receiving the uplink data sent by the UE, the BS sends a NACK to the UE; however, the BS does not redeliver the PDCCH signaling of scheduling retransmission. Therefore, the HARQ entity of the UE firstly instructs the corresponding HARQ process to perform the non-adaptive retransmission, the HARQ process may check whether the MCS is marked as normal, and if the MCS is marked as normal, the HARQ process may perform the non-adaptive retransmission. When the UE performs the retransmission in a non-adaptive manner, the normal MCS acquired in step 205 may be utilized, and the RV may be obtained in the order of RV0, RV2, RV3 and RV1. If the MCS is marked as abnormal, the retransmission is not performed.

According to this embodiment, in the uplink data transmission performed by the UE, if the initial transmission is determined according to the NDI in the received PDCCH signaling sent by the BS, the HARQ entity firstly carries the data TB to be transmitted onto the buffer and instructs the corresponding HARQ process to perform the transmission. When the HARQ process determines that the MCS in the received PDCCH signaling is a normal MCS, the uplink data transmission is performed. Therefore, the effectiveness of the uplink data transmission is guaranteed and when the uplink data is transmitted, packet loss and false indication of a lower layer to transmit data are avoided.

An uplink data transmission method according to an another embodiment of the present invention is provided, which includes the following steps.

Steps 301 to 305 are the same as steps 101 to 105 in the embodiment illustrated in the FIG. 1.

In step 306, if the MCS is an abnormal MCS, the HARQ process selects an MCS in an MCS list to perform the uplink data transmission. The selected MCS may be a previously used one. In the course of the previous uplink data transmission, the UE may save the adopted MCS locally to form the MCS list. If the received MCS is an abnormal MCS, an MCS in the MCS list may be selected to perform the retransmission.

If the BS receives the uplink data sent by the UE and successfully decodes the data, after the UE sends the uplink data, the BS sends an ACK, indicating a successful data transmission by the UE for this time.

According to this embodiment, in the uplink data transmission performed by the UE, if the initial transmission is determined according to the NDI in the received PDCCH signaling sent by the BS, the UE determines whether the MCS in the PDCCH signaling sent by the BS is a normal MCS, and if the MCS is a normal MCS, performs the uplink data transmission. Therefore, the effectiveness of the uplink data transmission is guaranteed and when the uplink data is transmitted, packet loss and false indication of a lower layer to transmit data are avoided. Moreover, if the MCS is an abnormal MCS, the HARQ process may select an MCS in the MCS list to perform the uplink data transmission, which further guarantees the effectiveness of the uplink data transmission.

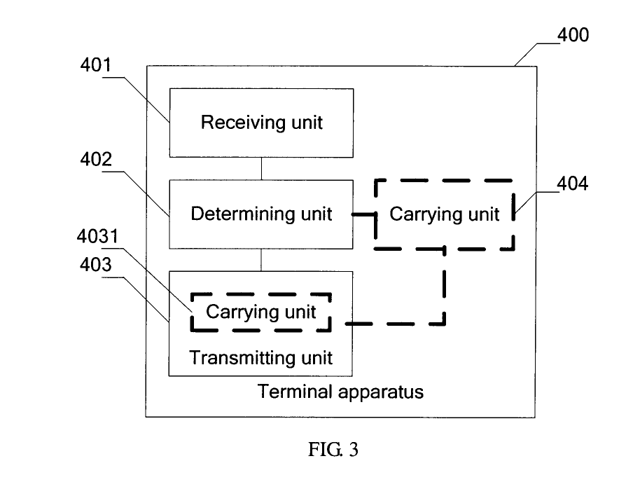

Referring to FIG. 3, a terminal apparatus 400 according to another embodiment of the present invention is provided, the terminal apparatus 400 includes a receiving unit 401, which is configured to receive first PDCCH signaling of scheduling initial transmission sent by a BS;

A determining unit 402, which is configured to determine whether an MCS in the first PDCCH signaling of scheduling retransmission is a normal MCS, if initial transmission is determined according to an NDI in the first PDCCH signaling of scheduling retransmission received by the receiving unit 401.

A transmitting unit 403, which is configured to perform an uplink data transmission, if the determining unit 402 determines that the MCS is a normal MCS.

In this embodiment, the terminal apparatus 400 loses the PDCCH signaling of scheduling initial transmission sent by the BS when performing the uplink data transmission, and after receiving a PDCCH signaling of scheduling retransmission further sent by the BS, determines whether the scheduled transmission is initial transmission according to the NDI in the PDCCH signaling of scheduling retransmission, if the scheduled transmission is initial transmission, determines whether the MCS in the PDCCH signaling of scheduling retransmission is a normal MCS, and if the MCS is a normal MCS, performs the uplink data transmission.

After successfully receiving and decoding the uplink data transmitted by the terminal apparatus 400, the BS sends an ACK to the terminal apparatus 400, and the receiving unit 401 receives the ACK.

Preferably, the transmitting unit 403 may further includes a carrying unit 4031. The carrying unit 4031 is configured to carry the data TB onto the HARQ Buffer, instruct the HARQ process to perform the initial transmission and mark the MCS as normal.

Preferably, the terminal apparatus 400 may further include a carrying unit 404. Connected with the determining unit 402 and the transmitting unit 403, the carrying unit 404 is configured to carry the TB onto the HARQ Buffer, if the initial transmission is determined by the determining unit 402 according to the NDI in the PDCCH signaling of scheduling retransmission, so as to instruct the HARQ process to perform the initial transmission of uplink data. The transmitting unit 403 is configured to transmit the TB carried onto the HARQ Buffer by the carrying unit 404, if the determining unit 402 determines that the MCS is marked as normal.

Preferably, the determining unit 402 is further configured to determine that the MCS is a normal MCS, if the RV in the PDCCH signaling of scheduling retransmission sent by the BS is RV0; and alternatively, determine that the MCS is a normal MCS, if the MCS contained in the PDCCH signaling of scheduling retransmission is non-empty.

Preferably, if the BS fails to acquire the uplink data after the transmitting unit 403 performs the uplink data transmission, the BS sends a NACK to the terminal apparatus 400 and redelivers a second PDCCH signaling of scheduling retransmission. Meanwhile, the receiving unit 401 further receives the NACK and the second PDCCH signaling of scheduling retransmission sent by the BS, and the NDI in the second PDCCH signaling of scheduling retransmission is the same as the NDI in the first PDCCH signaling of scheduling initial transmission. The transmitting unit 403 performs an adaptive retransmission after determining that the MCS is marked as normal.

Preferably, if the BS fails to acquire the uplink data after the transmitting unit 403 performs the uplink data transmission, the BS sends a NACK to the terminal apparatus 400 but does not redeliver the second PDCCH signaling of scheduling retransmission. Therefore, the receiving unit 401 further receives the NACK sent by the BS. The transmitting unit 403 performs a non-adaptive retransmission after determining that the MCS is marked as normal.

The first PDCCH signaling of scheduling retransmission in this embodiment may also be the PDCCH signaling of scheduling initial transmission. That is, the treatment to the PDCCH signaling of scheduling initial transmission is similar to that to the first PDCCH signaling of scheduling transmission.

In this embodiment, in the uplink data transmission, after receiving the PDCCH signaling further sent by the BS, the terminal apparatus 400 determines whether the scheduled transmission is initial transmission according to the NDI in the PDCCH signaling further sent by the BS, if it is the initial transmission, determines whether the MCS in the PDCCH signaling is a normal MCS, and if the MCS is a normal MCS, performs the uplink data transmission. Therefore, the effectiveness of the uplink data transmission is guaranteed and when the uplink data is transmitted, packet loss and false indication of a lower layer to transmit data are avoided. Moreover, if the BS fails to acquire the uplink data in the uplink data transmission, the retransmission is performed according to the PDCCH signaling sent by the BS, which further guarantees the effectiveness of the uplink data transmission.

Through the descriptions of the preceding embodiments, persons skilled in the art may understand that the present invention may be implemented by hardware only or by software and a necessary universal hardware platform. However, in most cases, using software and a necessary universal hardware platform are preferred. Based on such understandings, all or part of the technical solution under the present invention that makes contributions to the prior art may be essentially embodied in the form of a software product. The software product may be stored in a storage medium. The software product includes a number of instructions that enable a computer device (personal computer, server, or network device) to execute the methods provided in the embodiments of the present invention.

Although the present invention has been illustrated and described with reference to some preferred embodiments of the present invention, it should be understood by persons of ordinary skill in the art that various variations to the present invention can be made in forms and details without departing from scope of the present invention.

What is claimed is:

1. An uplink data transmission method, comprising:
receiving first Physical Downlink Control Channel (PDCCH) signaling sent by a Base Station (BS); and
if a transmission scheduled in the first PDCCH signaling is determined as an initial transmission according to a New Data Indicator (NDI) in the first PDCCH signaling, and a Modulation Code Scheme (MCS) in the first PDCCH signaling is determined as a normal MCS, performing an uplink data transmission.

2. The uplink data transmission method according to claim 1, wherein in the uplink data transmission, a data Transport Block (TB) is carried onto a Hybrid Automatic Repeat reQuest (HARQ) Buffer, an HARQ process is instructed to perform the uplink data transmission and the MCS is marked as normal.

3. The uplink data transmission method according to claim 1, wherein before the MCS in the first PDCCH signaling is determined as the normal MCS, the method further comprises: a data TB is carried onto an HARQ Buffer, an HARQ process is instructed to perform the uplink data transmission; and
the MCS in the first PDCCH signaling is determined as a normal MCS, performing the uplink data transmission comprises:
the HARQ process determines that the MCS is the normal MCS, performing the uplink data transmission and marking the MCS as normal.

4. The uplink data transmission method according to claim 1, wherein the MCS in the first PDCCH signaling is determined as a normal MCS comprises:
if a Redundancy Version (RV) in the first PDCCH signaling is RV0, the MCS is determined as the normal MCS.

5. The uplink data transmission method according to claim 1, wherein the MCS in the first PDCCH signaling is determined as a normal MCS comprises:
if the MCS contained in the first PDCCH signaling is non-empty, the MCS is determined as the normal MCS.

6. The uplink data transmission method according to claim 1, further comprising: if the MCS is an abnormal MCS, an MCS is selected in an MCS list for the uplink data transmission.

7. The uplink data transmission method according to claim 2, further comprising: receiving a Negative Acknowledgement (NACK) and second PDCCH signaling sent by the BS, wherein the NACK and the second PDCCH signaling are sent by the BS if the BS fails to acquire the uplink data, and an NDI in the second PDCCH signaling is the same as the NDI in the first PDCCH signaling; and
performing an adaptive retransmission if the MCS is marked as normal.

8. The uplink data transmission method according to claim 3, further comprising: receiving a NACK and second PDCCH signaling sent by the BS, wherein the NACK and the second PDCCH signaling are sent by the BS if the BS fails to acquire the uplink data, and an NDI in the second PDCCH signaling is the same as the NDI in the first PDCCH signaling; and
performing an adaptive retransmission if the MCS is marked as normal.

9. The uplink data transmission method according to claim 2, further comprising: receiving a NACK sent by the BS, wherein the NACK is sent by the BS if the BS fails to acquire the uplink data; and
performing a non-adaptive retransmission if the MCS is marked as normal.

10. The uplink data transmission method according to claim 3, further comprising: receiving a NACK sent by the BS, wherein the NACK is sent by the BS if the BS fails to acquire the uplink data; and
performing a non-adaptive retransmission if the MCS is marked as normal.

11. The uplink data transmission method according to claim 1, wherein a transmission scheduled in the first PDCCH signaling is determined as an initial transmission according to the NDI in the first PDCCH signaling comprises:
comparing a saved NDI with the NDI in the first PDCCH signaling, and if the two NDIs are different, the transmission scheduled in the first PDCCH signaling is determined as the initial transmission.

12. A terminal apparatus, comprising:
a receiving unit, configured to receive first Physical Downlink Control Channel (PDCCH) signaling sent by a Base Station (BS);
a determining unit, configured to determine whether a Modulation Code Scheme (MCS) in the first PDCCH signaling is a normal MCS, if a transmission scheduled in the first PDCCH signaling is determined as initial transmission according to a New Data Indicator (NDI) in the first PDCCH signaling received by the receiving unit; and
a transmitting unit, configured to perform an uplink data transmission if the determining unit determines that the MCS is a normal MCS.

13. The terminal apparatus according to claim 12, wherein the transmitting unit further comprises: a carrying unit, configured to carry a data Transport Block (TB) onto a Hybrid Automatic Repeat reQuest (HARQ) Buffer, instruct an HARQ process to perform the uplink data transmission and mark the MCS as normal.

14. The terminal apparatus according to claim 12, wherein the terminal apparatus further comprises: a carrying unit, configured to carry a data TB onto an HARQ Buffer, and instruct the HARQ process to perform the uplink data transmission if the determining unit determines the transmission scheduled in the first PDCCH signaling as the initial transmission according to the NDI in the first PDCCH signaling; and
the transmitting unit is further configured to perform the uplink data transmission on the data TB carried by the carrying unit onto the HARQ Buffer and mark the MCS as normal, if the determining unit determines that the MCS is the normal MCS.

15. The terminal apparatus according to claim 12, wherein the determining unit is further configured to determine that the MCS is the normal MCS if a Redundancy Version (RV) in the first PDCCH signaling is RV0.

16. The terminal apparatus according to claim 12, wherein the determining unit is further configured to determine that the MCS is the normal MCS if the MCS contained in the first PDCCH signaling is non-empty.

17. The terminal apparatus according to claim 13, wherein the receiving unit is further configured to receive a Negative Acknowledgement (NACK) and second PDCCH signaling sent by the BS, the NACK and the second PDCCH signaling are sent by the BS if the BS fails to acquire the uplink data, and an NDI in the second PDCCH signaling is the same as the NDI in the first PDCCH signaling; and
the transmitting unit is further configured to perform an adaptive retransmission if the MCS is marked as normal.

18. The terminal apparatus according to claim 14, wherein the receiving unit is further configured to receive a Negative Acknowledgement (NACK) and second PDCCH signaling sent by the BS, the NACK and the second PDCCH signaling are sent by the BS if the BS fails to acquire the uplink data, and an NDI in the second PDCCH signaling is the same as the NDI in the first PDCCH signaling; and
the transmitting unit is further configured to perform an adaptive retransmission if the MCS is marked as normal.

19. The terminal apparatus according to claim 13, wherein the receiving unit is further configured to receive a NACK sent by the BS, and the NACK is sent by the BS if the BS fails to acquire the uplink data; and
the transmitting unit is further configured to perform a non-adaptive retransmission if the MCS is marked as normal.

20. The terminal apparatus according to claim 14, wherein the receiving unit is further configured to receive a NACK sent by the BS, and the NACK is sent by the BS if the BS fails to acquire the uplink data; and
the transmitting unit is further configured to perform a non-adaptive retransmission if the MCS is marked as normal.
